(19) United States
(12) Patent Application Publication
(10) Pub. No.: US 2020/0290437 A1
(43) Pub. Date: Sep. 17, 2020

(54) SHADE APPARATUS FOR USE WITH VEHICLES

(71) Applicant: AISIN TECHNICAL CENTER OF AMERICA, INC., Northville, MI (US)

(72) Inventor: Kamin MANATPON, Ann Arbor, MI (US)

(73) Assignee: AISIN TECHNICAL CENTER OF AMERICA, INC., Northville, MI (US)

(21) Appl. No.: 16/298,835

(22) Filed: Mar. 11, 2019

(51) Int. Cl. B60J 1/20

(52) U.S. Cl. CPC B60J 1/2013; B60R 1/04

(57) ABSTRACT

Shade apparatus for a vehicle are disclosed. A disclosed the shade apparatus for a vehicle windshield includes a shade movable along the windshield in a front-rear direction of the vehicle. The shade apparatus also includes a drive unit to move the shade. The shade includes a groove portion to accommodate a room mirror mounted on the windshield and the groove portion extend from the front end of the shade toward the rear of the shade.

### FIELD OF THE DISCLOSURE

This disclosure relates generally to vehicles and, more particularly, to shade apparatus for use with them.

### BACKGROUND

Motor vehicles typically employ shade system to protect passengers including the driver from sunlight. Some vehicles having sunroof functionality utilize a shade positioned on a top of a vehicle. For example, passengers use a sunroof to take in the sunlight into the vehicle. On the other hand, the passenger uses a shade system to block the sunlight poured through the sunroof that is transparent.

### SUMMARY

An example shade apparatus for a vehicle windshield includes a shade movable along the windshield in a front-rear direction of the vehicle. The shade apparatus also includes a drive unit to move the shade. The shade includes a groove portion to accommodate a room mirror mounted on the windshield and the groove portion extends from a front end of the shade toward a rear of the shade.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a view of an example vehicle in which examples disclosed herein can be implemented;

FIG. 2 is a block diagram of the example shade apparatus of FIG. 1.

FIG. 3 is a detailed view of an example shade apparatus at position A in accordance with the teachings of this disclosure;

FIG. 4 is a detailed view of an example shade apparatus at position B in accordance with the teachings of this disclosure;

FIG. 5A is a detailed view of the example closing mechanism when it is closed;

FIG. 5B is a detailed view of the example closing mechanism when it is opened;

FIGS. 6A and 6B are detailed views of the magnet of the example closing mechanism;

FIG. 7 is an operation diagram of the example closing mechanism;

The figures are not to scale. In general, the same reference numbers will be used throughout the drawing(s) and accompanying written description to refer to the same or like parts.

### DETAILED DESCRIPTION

Some known shade apparatuses for a sunroof or panoramic windshield of a vehicle include a shade (e.g., a roll shade) that is protect from sunlight. In recent years, the shape of the windshield changes according to the change in the shape of the vehicle, and the shade system is expected to expand the covering range. To extend covering range (e.g., beyond a room mirror of the vehicle, etc.), some known shade apparatuses have the method for avoiding the room mirror.

For example, a shade apparatus of U.S. Pat. No. 6,857,693 has is provided with a shade device for a driver and a shade device for a passenger, and there is a problem that the number of parts increase and it is not possible to sufficiently shield the sunlight (For example, a gap is generated between the shades). In addition, a shade apparatus of U.S. Pat. No. 6,857,693 realizes the movement of the shade by changing the position of the room mirror. Accordingly, effectiveness of these known shade apparatuses is dependent on changing in specifications of the vehicle and increasing the number of parts.

Shade apparatus for a vehicle windshield is disclosed. Examples disclosed herein provide an example shade apparatus that is configured the shade including a groove portion (e.g. extending from a front end of the shade toward a rear of the shade.) to movable along the windshield in a front-rear direction of the vehicle. Since the groove portion can accommodate the room mirror, the shade can move beyond the room mirror. As a result, a shade is enabled to extend beyond the room mirror and it is possible to sufficiently shield the sunlight.

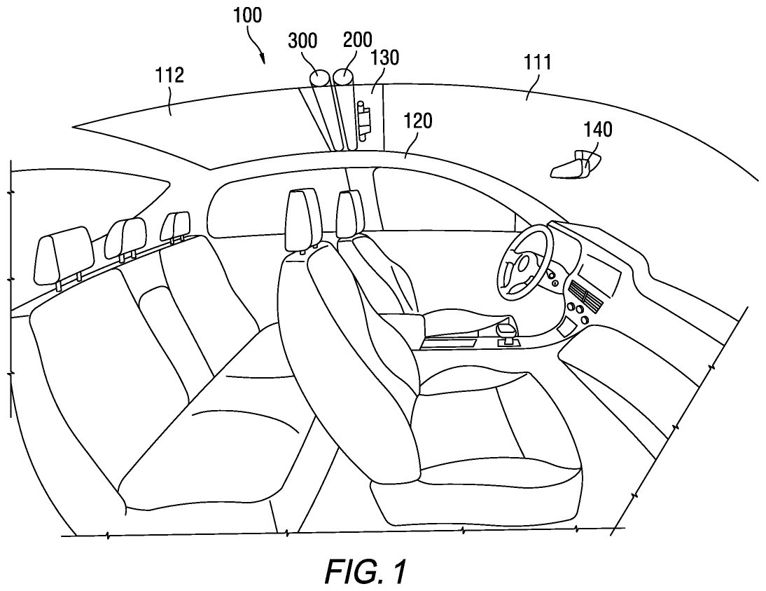

FIG. 1 is a view of an example vehicle (e.g., a car, a van, a truck, a sport utility vehicle (SUV), etc.) 100 in which examples disclosed herein can be implemented. According to the illustrated example of FIG. 1, the vehicle 100 includes a panoramic windshield 111, which is located the front side of the vehicle, and a sunroof 112, which is located the rear side of the vehicle 100, that are mounted between vehicle frames 120 and a center frame 130. Further, in some examples, the vehicle 100 also includes a room mirror 140 that is mounted on the panoramic windshield 111. In addition, the vehicle 100 includes a shade apparatus 200 for covering the panoramic windshield 111 and a roof shade apparatus 300 for covering the sunroof 112. These shade apparatuses 200, 300 are stored in the center frame 103.

Although FIG. 1 depicts the shade apparatus 200 for covering the panoramic windshield 111, in some example, the shade apparatus 200 is implemented using for covering a general windshield.

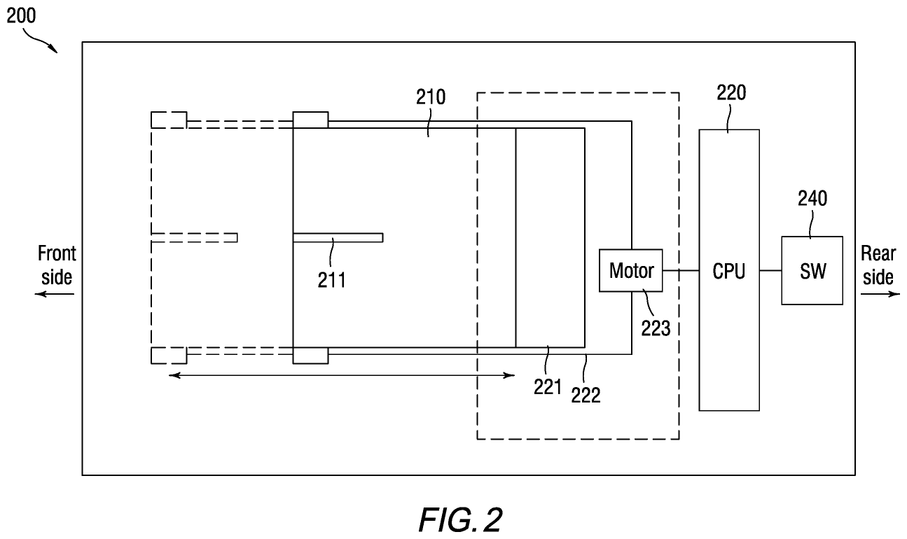

FIG. 2 is a block diagram of the shade apparatus 200 of FIG. 1. As shown in FIG. 2, the shade apparatus 200 includes a shade 210 for the panoramic windshield 101a, a drive unit 220 for movable the shade 210, a microcomputer 230 and a switch 240. Further, the shade 210 is roll shade and includes a groove portion 211. The groove portion 211 extends from a front end of the shade 210 toward a rear of the shade 210. The drive unit 220 is comprised of a shade roller 221 on which the shade 220 is wound, two shade cables 222 to move shade 210 and a motor 223 to push the shade cables 222 toward the front of the vehicle 100. The shade roller 221 includes spring mechanism to wind the shade 210. One end of the shade cables 222 are provided at the front end of the shade 210 and the other end is connected to the motor 223.

As shown in FIG. 2, when user push the switch 240, the microcomputer 230 catch the signal from the switch 240. Then, the microcomputer 230 send the signal for drive to the motor 223 and the motor 223 rotates and push the shade cables 222 toward the front of the vehicle 100. Therefore, the shade 210 can move the front of the vehicle 100. In the occasion of shade cables 222 is pulled rearward by the motor 223, the shade roller 221 rotated will retract the shade 210 back with spring mechanism to keep tension on the shade 210. Accordingly, the shade 210 can move the vehicle front-rear direction.

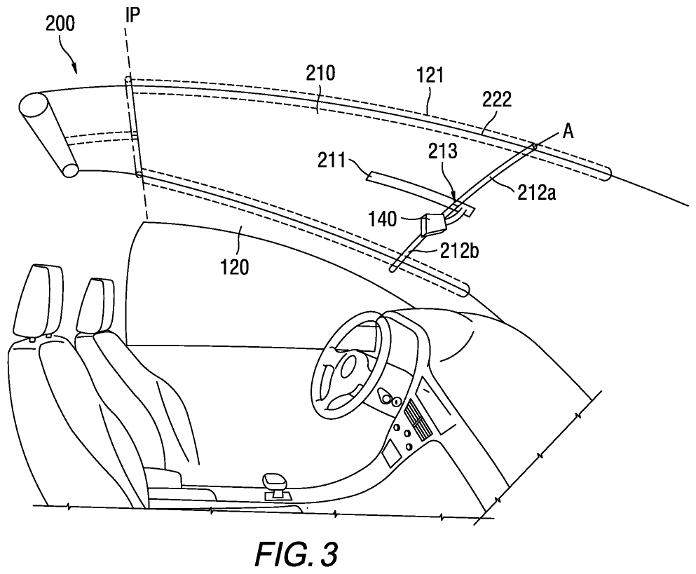

FIG. 3 is a detailed view of an example shade apparatus at position A in accordance with the teachings of this disclosure. The shade 210 of the shade apparatus 200 is stored in the center frame 130 and is located as initial position IP (indicated the broken line) at the front end of the shade 210 before driving the drive unit 220. Then, the front end of the shade 210 moves to a position A by the drive unit 220 driving. The position A is that the front end of the shade 210 contacts the room mirror 140 and is indicated by a solid line in FIG. 3.

As shown in FIG. 3, the shade 210 includes two leading edge bars 212a, 212b which are divided at an opening portion of the groove portion 211 provided at the front end of the shade 210. In addition, when shade 210 move from the initial position IP to the position A, the shade 210 moves along a shade rail 121 which extend in the vehicle front-rear direction on the vehicle flame 120 and is formed along the panoramic windshield 111. Further, the shade rail 121 supports the shade 210 via attached portions of the shade cables 222. The shade cables 222 runs along the shade rail 121. Accordingly, the shade 210 can move to the position A while maintaining the shape by merely rotating the Shade roller 221 of the driving unit 220. At ends of the leading edge bars 212a, 212b divided, a closing mechanism 213 to close the opening portion of the groove portion 211 is provided.

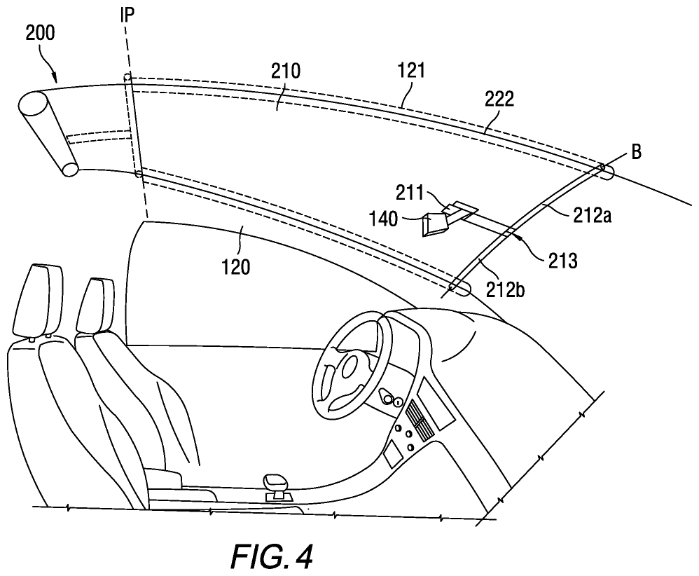

FIG. 4 is a detailed view of an example shade apparatus at position B in accordance with the teachings of this disclosure. The shade 211 of the shade apparatus 200 can extend from the position A to a position B by the drive unit 220 driving. The position B is further located on the vehicle front side than the room mirror 140. when the front end of the shade 210 achieved to the position A, the opening portion of the groove portion 211 opens. Then, the shade 210 is moved to the position A. At this time, the room mirror 140 go through the opening portion of the groove portion 211 and is accommodated in the groove portion 211. The length of the groove portion 211 in the vehicle front-rear direction needs at least a length corresponding to the distance between the position A and the position B in the vehicle front-rear direction. The range of extension from the position A to the position B depends on the vehicle shape (especially the design of the pillar).

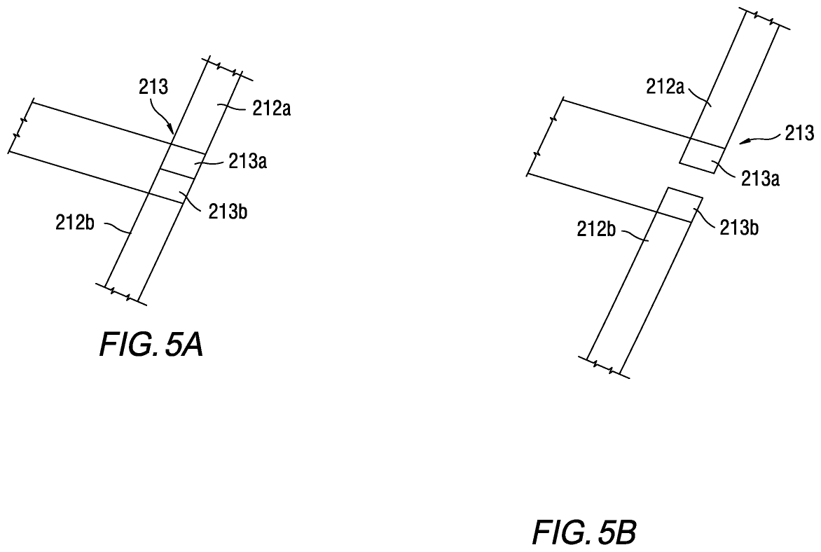

FIG. 5A is a detailed view of the example closing mechanism when it is closed and FIG. 5B is a detailed view of the example closing mechanism when it is opened. The shade 210 is provided two ends of the leading edge bars 212a, 212b that are divided for formed the opening portion of the groove portion 211. As show in FIG. 5A, the shade 201 includes a closing mechanism 213 at two ends of the leading edge bars 212a, 212b. The closing mechanism 213 is comprised of a magnet member 213a (or 213b) provided on at least one of both ends of the leading edge bars 212a (or 212b) and a magnet member 213b (or 213a), or a steel member 213b (or 213a), provided on the other end of the leading edge bar 212b (or 212a). The closing mechanism 213 can close when a magnet member 213a sticks, for example, a magnet member 213b. As show in FIG. 5B, the closing mechanism 213 can automatic or manual open when a magnet member 213a is prevented from sticking, for example, a magnet member 213b.

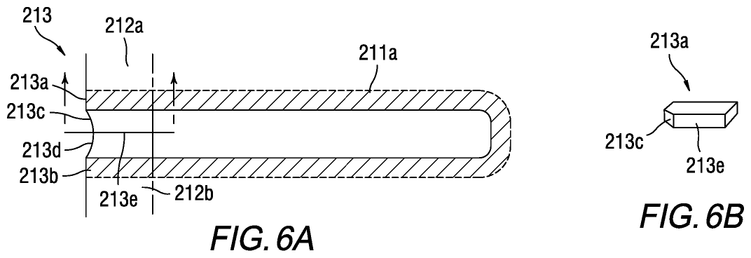

FIGS. 6A and 6B are detailed views of the magnet of the example closing mechanism. Ends of the two leading edge bars 212a, 212b each mount a magnet 213a, 213b. The magnet 213a (or 213b) are formed a notch 213c (213d) at the front end of the shade 210 and recessed toward an inside of the shade 210. In addition, the closing mechanism 210 includes a surface 213e to be detached and attached formed in the front-rear direction of the vehicle. The surface 213e is to stick the magnets 213b, 213c. The surface 213e coincides with an apex of the notches 213c. As show FIG. 6A, a periphery of the groove portion 211a is reinforced by reinforcing members. Accordingly, the groove portion 211 can improve durability.

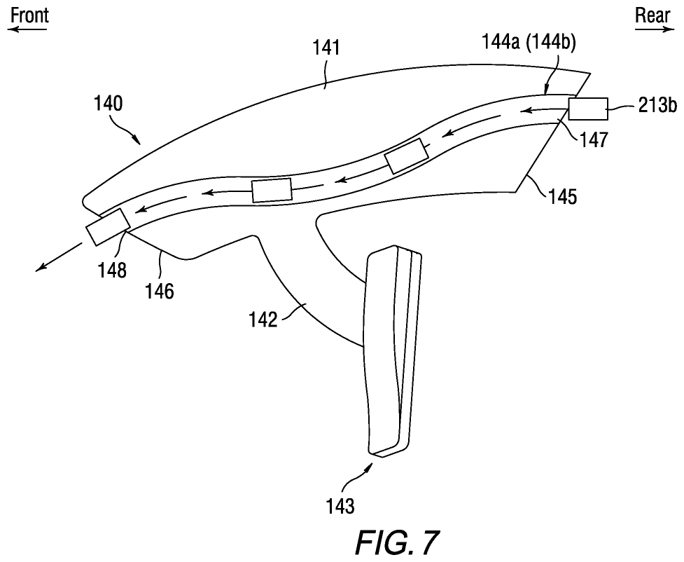

FIG. 7 is an operation diagram of the example closing mechanism. The rear mirror 140 includes a mirror base 141 mounted on the windshield 111, a support portion 142 provided the mirror base 141 and a mirror portion 143 is mounted at an end of the support portion 142. The mirror base 142 include mirror grooves 144a, 144b extended in the front-rear direction of the vehicle 100 and formed on both right and left sides. A rear end portion 145 of the base portion 141 in the front-rear direction of the vehicle has a convex shape. A front end portion 146 of the base portion 141 in the front-rear direction of the vehicle also has a convex shape. The rear end portion 145 includes an enter gate 147 of the mirror grooves 144a, 144b and the front end portion 146 includes an exit gate 148 of the mirror grooves 144a, 144b.

As show FIG. 7, when the closing mechanism 213 achieved the rear mirror 140, the front end of the shade 210 contacts the rear end portion 145. Since the rear end portion 145 has the convex shape and the magnet 213a (or 213b) includes the notch 213c (213d) at the front end of the shade 210, that the magnet 213a is prevented from sticking the magnet 213b by the rear end portion 145. Accordingly, the closing mechanism 213 open. Then, the magnets 213a, 213b enter mirror grooves 144a, 144b from the enter gate 147 and move along mirror grooves 144a, 144b with the movement of the shade 210 to the exit gate 148 of mirror grooves 144a, 144b. Since the front end portion 146 has the convex shape, a distance between the magnets 213a, 213b decrease as the magnets 213a, 213b move to the exit gate 148. When the magnets 213a, 213b move beyond the exit gate 148, the magnets 213a, 213b can stick again. Accordingly, the closing mechanism 213 close and the groove portion 211 accommodate the rear mirror 140.

It will be appreciated that shade apparatus for use with vehicles disclosed in the foregoing description provide numerous advantages. Examples disclosed herein provide a shade apparatus including a groove portion and a closing mechanism provided on a shade. Disclosed examples effectively extend a shade beyond room mirror while maintaining effectiveness of the shade.

Although certain example apparatus has been disclosed herein, the scope of coverage of this patent is not limited thereto. Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A shade apparatus for a vehicle windshield, comprising:
a shade movable along the windshield in a front-rear direction of the vehicle; and
a drive unit for moving the shade,
the shade including a groove portion to accommodate a rear mirror mounted on the windshield,
the groove portion extending from a front end of the shade toward a rear of the shade.

2. The shade apparatus of claim 1, wherein
the shade includes two leading edge bars divided at the front end of the shade;
the groove portion includes an opening portion formed by the two leading edge bars at the front end of the shade; and
the shade includes a closing mechanism to close the opening portion between ends of the two leading edge bars.

3. The shade apparatus of claim 2, wherein the closing mechanism is a magnet mounted on at least one of the two leading edge bars at the front end of the shade.

4. The shade apparatus of claim 1, wherein
the closing mechanism includes a surface to be detached and attached formed in the front-rear direction of the vehicle, and a notch formed at the front end of the shade and recessed toward an inside of the shade, and
the surface coincides with an apex of the notch.

5. The shade apparatus of claim 1, wherein a periphery of the groove portion is reinforced by reinforcing members.

6. The shade apparatus of claim 1, wherein
the shade is a roll shade; and
the drive unit includes a shade roller on which the roll shade is wound, two shade cables to move shade and a motor to push and pull the shade cables in the front-rear direction of the vehicle.
